(19) United States
(12) Patent Application Publication
(10) Pub. No.: US 2007/0110912 A1
(43) Pub. Date: May 17, 2007

(54) Method of preventing substrate colour changes on impregnation

(75) Inventor: Burkhard Standke, Lorrach (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, DUESSELDORF GERMANY (DE)

(21) Appl. No.: 10/581,690

(22) PCT Filed: Nov. 30, 2004
(86) PCT No.: PCT/EP04/53176

§ 371 Date: Jun. 6, 2006

(30) Foreign Application Priority Data
Jan. 17, 2004 (DE) 10-2004-002-499.5

(51) Int. Cl. B05D 3/12; B05D 3/02; B05D 7/00

(52) U.S. Cl. 427/430.1; 427/372.2; 427/421.1; 427/429; 427/355

(57) ABSTRACT

The present invention relates to a special method of preventing substrate colour changes when impregnating porous inorganic substrates, by first applying to the target substrate surface a primer composition, drying and curing the primer system, the substrate surface acquiring hydrophobic and oleophobic properties such that drops of water applied thereto evaporate before they penetrate into the substrate and a drop of n-decane likewise applied thereto and left to act for 30 seconds can be removed, without the drops leaving dark spots on the substrate surface, and then carrying out the impregnation. The present invention further relates to the use of fluoroalkyl-modified and/or fluorofunctional acrylate systems or fluoroalkyl-/aminoalkyl-/alkoxyand/or hydroxy-functional siloxane systems or fluoroalkyl-functional silane and/or siloxane systems or mixtures of at least two of the aforementioned substances or solutions thereof in water and/or alcohol as primers for preventing substrate colour changes in the case of architectural preservation by impregnation.

The present invention relates to a special method of preventing substrate intensification effects, i.e., changes in color when impregnating porous inorganic substrates, particularly for architecture preservation measures.

Impregnations of porous mineral building materials for the surface repulsion of oil and water have long been used in the art, and the subject is often dealt with using the term “easy to clean”. More recently there have also been impregnations which act to repel dirt, ink, and paint. This activity is also referred to popularly as the antigraffiti effect. The impregnations are then antigraffiti impregnations.

One example of such an antigraffiti impregnation is a product of the kind apparent from example 1 of DE-A 199 55 047.

EP 1 193 302 A2 teaches a process for rendering inorganic substrates easy to clean in two steps, the emphasis being in particular on minimum consumption of impregnating composition, i.e., on the economy of the process.

EP 1 358 946 A1 discloses a process for impregnating porous mineral substrates, which employs the“airless” or “HVLP” spraying technology.

For the water and oil-repellent impregnation of mineral substrates use is also made of fluorinated resin systems, such as various Zonyl grades from DuPont or corresponding products from other manufacturers, such as Wacker BS 28 or Wacker BS 29, for example.

For the purely water-repellent treatment of mineral substrates it is common to use liquid silicone resins, silicone resin emulsions or solutions of silicone resins, such as Wacker BS 290 or Goldschmidt HL 100, for example.

Resin solutions or emulsions as well, acrylate resins for example, and also combinations of the impregnating compositions referred to above are also used in the art for protecting surfaces of mineral building materials.

A phenomenon common to all of these impregnations is that they result in a deepening in color, in some cases severe and sustained, of the treated substrate surfaces, particularly when they are applied in high concentration to mineral surfaces. This effect, also called surface intensification, is frequently undesirable, particularly when, as part of an architectural preservation measure, only parts of a facade are to be protected. For example, building facades are often protected against graffiti only up to a height of 2 to 3 m. For this reason, the aforementioned impregnating compositions are frequently only used in a low concentration, despite the fact that a high concentration would be desirable in order to obtain or enhance the desired effects, such as permanent protection from graffiti. In the case of permanent antigraffiti impregnation, in accordance with EP 1 193 302 A2, for example, a marked color deepening is often evident in the treated as compared with the untreated substrate.

It was therefore an object to provide a means of mitigating color changes experienced when impregnating porous inorganic substrates.

The object stated is achieved in accordance with the invention as specified in the claims.

Thus it has been found, surprisingly, that the color-deepening effect outlined above can be virtually or even completely avoided if beneath the impregnation an effective primer system is placed, without the effectiveness of the impregnation being lessened by the additional step. As effective primers, substances which prevent a subsequently applied impregnation penetrating into the substrate have proven advantageous. In other words, the priming should in accordance with the invention be executed such that the primer system already has effective hydrophobic and oleophobic properties before the impregnating composition is applied, since an uncured active substance in the impregnating material also possesses the character of a solvent (apolar liquid with low surface tension). Thus with the present method it must appropriately be ensured that, before the impregnation is applied, the primer system must have cured to such an extent that the resulting hydrophobic and oleophobic effect is sufficient to prevent the impregnating composition penetrating into the substrate. Moreover, the primer composition as well is suitably to be chosen such that it does not alter the color of the substrate surface.

Additionally it has been found that numerous hydrophobizing and oleophobizing substances which are commonly used in dilute form as impregnating compositions are advantageously suitable for this purpose. Such substances include, in particular, fluoro-functional products, such as, for example—but not exclusively—those disclosed by EP 0 846 716 A2, EP 0 846 717 A2, DE-A 199 55 047, and EP 1 193 302 A2.

With the present method, then, it is preferred as primers to use fluoroalkyl-bearing siloxanes or silicone resins and also fluorinated resin systems, such as products from the branded range Zonyl®, especially Zonyl® 9361, 225, 210, 9027, 8740, 321, and 329, or corresponding products from other manufacturers, such as Wacker BS 28 or BS 29, for example. Common to all these products is that they contain fluoroalkyl functions and are able to produce strong hydrophobic and oleophobic effects on the surface of mineral substrates.

The present invention accordingly provides a method of preventing substrate intensification effects when impregnating porous inorganic substrates, by first applying to the target substrate surface a primer composition, drying and curing the primer system, the substrate surface acquiring hydrophobic and oleophobic properties such that drops of water applied thereto evaporate before they penetrate into the substrate and a drop of n-decane likewise applied thereto and left to act for about 30 seconds can be removed, without the drops leaving dark spots on the substrate surface, and then conventionally carrying out the impregnation, in particular an easy-to-clean impregnation, an antigraffiti impregnation for example.

The method of the invention therefore has the advantageous effect that the original color, i.e., the colored appearance of the substrate, becomes unalterable, or alterable only to an acceptable extent, in general, by a specific and well-controlled priming or sealing system which repels water and oil, in other words all liquids in principle, and that in this way the subsequently applied impregnating or coating composition is prevented from deep-down penetration, which would otherwise lead to an additional, unacceptable deepening of color, particularly for what are called easy-to-clean impregnating compositions or antigraffiti impregnations, such as those apparent from documents including WO 92/21729, EP 0 846 716 A2, EP 0 846 717 A2, DE-A 199 55 047, EP 1 193 302 A2, EP 1 358 946 A1, and WO 88/10284. The content of the abovementioned documents and also of those mentioned below is explicitly to be considered in its entirety part of the disclosure content of the present specification.

Thus with the method of the invention it is preferred to employ a primer which comprises at least one fluorofunctional component, also referred to below as active substance.

Particular preference is given to primers which comprise at least one fluoroalkylsilyl-functional component.

Used in particular with advantage are primers which comprise at least one cocondensate of at least one fluoroalkyl-functional silane and at least one aminoalkyl-functional silane or which comprise at least one fluoroalkyl-modified acrylate polymer and/or at least one fluorofunctional acrylic copolymer.

It is appropriate to employ primers based on water, on alcohol or on water/alcohol. Said primers can also be used, however, as a concentrated active substance system.

As preferred examples mention may be made here of the following primers: Zonyl® 321 or Zonyl® 329 or aqueous solutions of Zonyl® 8857, 8867, 8952, 8740 or Zonyl® 9027 or Protectosil® Antigraffiti, Protectosil® SC Concentrate, DYNASYLAN® F 8815, DYNASYLAN® F 8800, SIVOClear, DYNASYLAN® F 8262 or DYNASYLAN® F 8263, and solutions thereof in water and/or alcohols or in a mixture of at least two of the aforementioned systems.

With the method of the invention it is appropriate to use a primer composition having a fluorofunctional active substance content of from 0.5 to 30% by weight, preferably with from 1 to 20% by weight, more preferably with from 3 to 15% by weight.

With the method of the invention the primer composition is applied preferably by spraying, brushing, rolling or knife coating.

Thus the primer composition. is applied advantageously at a rate of from 25 to 200 g/m², preference being given to rates of from 40 to 150 g/m², more preferably from 50 to 130 g/m², very preferably from 60 to 110 g/m², and in particular from 70 to 90 g of primer composition per m² of target substrate surface.

It is further of advantage with the method of the invention if the primer system is dried and cured at a temperature of from 5 to 40° C. and with a relative atmospheric humidity of from 30% to 80%.

In general, with the method of the invention, the hydrophobizing and oleophobizing primer system is chosen and executed such that a drop of water and/or ethanol applied to this primer system leaves no dark spot on the substrate before it evaporates, and a drop of oil or organic solvent applied to this primer system runs off as a bead from the substrate surface without leaving a dark patch or spot, i.e., a change in color in the primed or sealed substrate surface. For the oil repellency test the model substance used is generally n-decane.

With the method of the invention a preferred impregnating composition is the product Protectosil® Antigraffiti or similar fluoroalkyl-/aminoalkyl-/alkoxy- and/or hydroxy-functional silane cooligomers, or a concentrated or an aqueous or an alcoholic solution or a solution containing water, organic or inorganic acid if desired, such as formic acid, acetic acid or hydrochloric acid, and also alcohol, such as methanol, ethanol or isopropanol, which comprises as active substance fluoroalkyl-/aminoalkyl-/alkoxy- and/or hydroxy-functional silane cooligomers. Or use may be made advantageously in accordance with the invention, as impregnating composition, of a monomeric fluoroalkylalkoxysilane, such as tridecafluoro-functional 1,1,2,2-tetrahydrooctyltrimethoxysilane or tridecafluoro-1,1,2,2-tetrahydrooctyltriethoxysilane, to give but a few examples, or of an aqueous or alcoholic formulation which includes at least one such fluoroalkylalkoxysilane or a partial hydrolysate of a fluoroalkylalkoxysilane or at least one corresponding oligomer. Thus, for example, the product from example 1 of EP 1 101 787 A2 can be used in accordance with the invention if it is diluted, preferably with water, in a weight ratio of from 1:2 to 1:15; other use concentrations can also be chosen, however.

With the method of the invention the impregnating composition as well is applied preferably by spraying, brushing, rolling or knife coating.

Particular suitability for the spray application of said compositions is processed by airless or HVLP processes; cf. EP 1 358 946 A1. These spraying techniques are advantageously suitable in the context of the method of the invention for the application both of said primer compositions and of the impregnating compositions.

With the method of the invention it is particularly preferred to use as primer composition Zonyl® 321, 329 or Zonyl® 9027 or a mixture of at least two of the aforementioned Zonyl® grades or corresponding diluted solutions in water and as impregnating composition Protectosil Antigraffiti, a fluoroalkyl-/triaminoalkyl-/alkoxy- and/or hydroxy-functional siloxane system.

The present invention accordingly also provides for the use of fluorofunctional or fluoroalkyl-modified acrylic resins from the series Zonyl® 321, Zonyl® 329, Zonyl® 8857, Zonyl® 8867, Zonyl® 8952, Zonyl® 8740, Zonyl® 9027 (cf. U.S. Pat. No. 5,798,415, EP 0 714 921 A1 inter alia) and also fluoroalkyl-/aminoalkyl-/alkoxy- and/or hydroxy-functional siloxane systems or fluoroalkylfunctional silane and/or siloxane systems from the series consisting of Protectosil® Antigraffiti, Protectosil® SC Concentrate respectively DYNASYLAN® F 8815 (cf. EP 1 101 787 A2), DYNASYLAN® F 8800 (cf. EP 0 846 716 A2 and EP 0 846 717 A2), SIVOClear (cf. DE Application 103 36 544.3), DYNASYLAN® F 8262, and DYNASYLAN® F 8263 (cf. EP 0 846 715 A2 and EP 1 033 395 A2), or mixtures of at least two of the aforementioned active substances or active substance systems, or solutions thereof in water and/or alcohol, as primer compositions for preventing substrate intensification effects in the case of architectural preservation by impregnation.

Generally speaking, the method of the invention involves a special priming step and at least one subsequent impregnating step. For the priming it is appropriate to use a composition which comprises a fluorofunctional compound as active substance, with the primer system applied to the target substrate having both hydrophobic and oleophobic properties after drying and curing, and thereby allowing the substrate surface to be protected against the penetration of the impregnating composition into the substrate and hence against unwanted changes in color. The special primer system thus advantageously prevents the intensification of sensitive, porous, i.e., absorbent substrates as a result of impregnation, with the porosity of the target substrates generally ranging from 0.5 to 20% by volume.

The primer thus generally comprises hydrophobizing and oleophobizing components, i.e., active substances, preferably fluoroalkylsilane systems, fluoroalkyl-modified acrylate polymer solutions or fluorinated acrylic copolymers. Said acrylate-based systems are in the case for example of Zonyl® 321 and 329, preferably cationic compositions which comprise acrylic copolymer and are based on water, on alcohol and/or on solvent.

The active substance content of such compositions, furthermore, is preferably from 0.5% to 30% by weight, more preferably from 1% to 10% by weight, very preferably from 2% to 8% by weight, and in particular from 3% to 5% by weight. Such compositions generally possess a pH of from 4 to 10, in particular from 4.5 to 6 (acidic systems) or from 7 to 9 (neutral to slightly basic systems).

Compositions which comprise at least one fluorofunctional acrylic polymer or acrylic copolymer, in the form for example of a solution, emulsion or dispersion, can possess a character which ranges preferably from highly mobile, liquid, through honeylike to pastelike. Examples of alcohols which can be used in this case include methanol, ethanol, and/or isopropanol—but not exclusively—or as solvent, for example, N-methylpyrrolidone.

The impregnation is preferably composed of water-soluble and fluoroalkysilane-based systems. Other impregnating compositions can be used as well, however, provided they can be applied to the primer system.

In order to avoid color deepening in the case of the primer it is appropriate with the method of the invention to use a primer composition which has an active substance concentration of =30% by weight. In order to ensure that the primer system is sufficiently effective, on the other hand, the primer composition used with the method of the invention ought to have an active substance concentration of =0.5% by weight.

Moreover, with the method of the invention, it should be ensured that the primer system has cured sufficiently, before the impregnation is applied, to prevent deep-down and hence color-altering penetration of the impregnation. The sufficient cure time for the primer system is generally dependent on the active substance concentration used, on temperature and atmospheric humidity, and on the nature of the active substance used. Thus in accordance with the invention a cure time, including drying time, for the primer of advantageously at least 4 hours should be ensured; appropriately this time is 6 hours, preferably 8 hours, more preferably 16 hours, very preferably one day, in particular from 32 to 48 hours, although a period of several days up to one week may even be necessary. The curing temperature is preferably between 5 and 60° C., more preferably from 10 to 40° C., and the relative atmospheric humidity which prevails or results outdoors in particular ought to be as low as possible, which is to say, preferably, from about 0% to 90%, more preferably from 10% to 80%. The target substrate surface, where necessary, can be additionally heated or uniformly conditioned. As a guide it can be stated that curing is comparatively more rapid when working at a higher temperature and lower atmospheric humidity and when a high active substance concentration is chosen.

Prior to the application of the impregnating composition, which is preferably done by spraying by the HVLP process, the primer must have cured sufficiently, in other words must possess not only particularly pronounced hydrophobic properties but also oleophobic properties, such that no liquid can penetrate too deeply—that is, with color-deepening effect—into the substrate's pore system.

As soon as the impregnating composition has been applied to the primer system, the impregnating composition can be dried and likewise cured in conventional manner, but without causing any discoloration of the substrate.

Hence the present method is of advantageous suitability in general for the prevention of substrate intensification effects, i.e., color deepening during the impregnation of porous inorganic substrates, particularly for the antigraffiti impregnation of substrates to be protected, preferably porous mineral substrates, such as constructions, parts of constructions, components, building materials, e.g., concrete, brick, natural stone and artificial stone, ceramic, fiber cement slabs, and mineral fiber slabs, to give but a few examples.

An advantageous feature of the method of the invention, particularly in the case of antigraffiti impregnations, is that it does not significantly affect the performance properties in terms of permanence and weathering stability of the impregnation, but does allow the visual appearance of the impregnated substrate to be improved substantially and sustainedly as compared with prior art processes.

Thus it is now possible to carry out an antigraffiti impregnation with virtually no change in the color of the substrate and at the same time in a highly effective way, even using an impregnating composition with a relatively high concentration.

The present invention is illustrated by the examples below, without restriction on its subject matter.

### EXAMPLES

In the examples below the inorganic or mineral substrate used is red Main sandstone. This substrate has proven particularly sensitive to intensification effects.

The antigraffiti properties are tested using a felttip pen (Edding 800). A line of felttip is applied to the treated substrate. After 5 minutes' drying an attempt is made to remove the line of felttip with ethanol and a clean absorbent cloth. If removal is complete, without leaving behind a shadow caused by ink which has penetrated into the substrate, the test is successfully passed. In the examples this test is referred to as the felttip test.

The color deepening effect is determined visually. If, following impregnation, the substrate looks as if it has been wetted completely with water, the result reads “severe color deepening”.

If the impregnated substrate is indistinguishable in color from the original, the result is “no color deepening”.

If a color deepening effect (darker color of the impregnating substrate) is visible only on closer viewing, the result is stated as “slight color deepening”.

If a distinct color deepening effect is perceptible without close inspection and at the first glance, but is significantly less pronounced than in the case of the completely wetted substrate, the result reads “color deepening”.

The liquid impregnating systems and the liquid primer systems are applied by HVLP spraying processes; cf. EP 1 358 946 A1. The application rate is determined by immediate differential weighing of the substrate and is reported in g/m².

In order for color deepening effects which become evident only over time to be made rapidly visible, the substrates are heated at 60° C. for 16 hours before the color deepening effect is assessed. Visual assessment is made after the substrates have cooled.

### Example 1 (Comparative Example)

Antigraffiti impregnation with a product corresponding to example 1 of DE 199 55 047 (hereinafter also referred to as antigraffiti impregnating composition or antigraffiti impregnation or AGI for short):

The AGI product is applied by spraying in three successive passes. Immediately after the second and third spraying operations fine droplets which have formed on the substrate are spread using a brush to form a uniform film of liquid on the surface. The drying time between the application passes is ½ hour in each case at a temperature of approximately 20° C. and a relative atmospheric humidity of approximately 50%. ½ hour after the first pass directly before the second pass a drop of water is applied to the substrate. It evaporates without leaving a dark spot. A drop of n-decane applied to the substrate and left to act for 30 seconds leaves a distinct dark spot. The final drying and curing time is around 16 hours at a temperature of approximately 60° C. Overall product consumption amounts to 200 g/m². The felttip test is passed. The impregnation produces color deepening on the substrate.

### Example 2 (Comparative Example)

Impregnation with Zonyl® 9027 (neat): Zonyl® 9027 (manufacturer: DuPont) product is applied by spraying in three successive passes. The drying time between the application passes is 1 hour in each case at a temperature of approximately 20° C. and a relative atmospheric humidity of approximately 50%. Immediately after the second and third spraying operations fine droplets which have formed on the substrate are spread using a brush to form a uniform film of liquid on the surface. The final drying and curing time is around 16 hours at a temperature of approximately 60° C. Overall product consumption amounts to 150 g/m². The felttip test is passed. The impregnation produces severe color deepening on the substrate.

### Example 3 (Comparative Example)

Impregnation with Zonyl® 321 (neat):

Zonyl® 321 (manufacturer: DuPont) product is applied by spraying in three successive passes. The drying time between the application passes is 1 hour in each case at a temperature of approximately 20° C. and a relative atmospheric humidity of approximately 50%. Immediately after the second and third spraying operations fine droplets which have formed on the substrate are spread using a brush to form a uniform film of liquid on the surface. The final drying and curing time is around 16 hours at a temperature of approximately 60° C. Overall product consumption amounts to 150 g/m². The felttip test is passed. The impregnation produces severe color deepening on the substrate.

### Example 4 (Comparative Example)

Impregnation with HL 100 (silicone resin impregnation, manufacturer: Goldschmidt):

HL 100 is applied in one pass at a temperature of approximately 20° C. and a relative atmospheric humidity of approximately 50%. The final drying and curing time is around 16 hours at a temperature of approximately 60° C. Overall product consumption amounts to 100 g/m². The substrate exhibits a strong water repellency effect. The felttip test, however, is not passed. The impregnation produces severe color deepening on the substrate.

### Example 5 (Comparative Example)

Priming with Zonyl® 329 (dilute), impregnation with a product corresponding to example 1 of DE 199 55 047 (AGI):

1 part by weight of Zonyl® 329 is mixed with 4 parts by weight of water and the mixture is applied by spraying at 100 g/m² to the substrate surface. Immediately after the substrate surface has dried (about ½ h after application) a drop of water is applied to it at a temperature of approximately 20° C. and a relative atmospheric humidity of approximately 50%. The drop of water penetrates into the substrate within a few minutes, leaving behind a dark spot. Immediately thereafter neat AGI is applied to the surface by spraying in two passes with an overall product consumption of 100 g/m². Between the application passes, fine droplets on the substrate surface are spread with a brush to form a uniform film of liquid. The drying time between passes is ½ an hour. The final drying and curing time is around 16 hours at a temperature of approximately 60° C. The felttip test is passed. The impregnation produces color deepening on the substrate.

### Example 6

Priming with Zonyl® 329 (dilute) and extension of the setting time, i.e., a lengthening of the drying and curing time of the primer system prior to impregnation with AGI (neat):

1 part by weight of Zonyl® 329 is mixed with 4 parts by weight of water and the mixture is applied by spraying at 100 g/m² to the substrate surface. The substrate is stored in the laboratory for 1 day at a temperature of approximately 20° C. and a relative atmospheric humidity of approximately 50%. The primer system produces only slight color deepening on the substrate. A drop of water is applied to the substrate. It evaporates completely from the substrate surface without penetrating into the substrate (no dark spot). A drop of n-decane applied to the substrate and left to act for 30 seconds, can be removed without leaving a dark spot. Thereafter neat AGI is applied to the surface by spraying in two passes with an overall product consumption of 100 g/m². Between the application passes, fine droplets on the substrate surface are spread with a brush to form a uniform film of liquid. The drying time between passes is ½ an hour. The final drying and curing time is around 16 hours at a temperature of approximately 60° C. The felttip test is passed. The impregnation produces only slight color deepening on the substrate.

### Example 7

Priming with Zonyl® 329 (very dilute), impregnation with AGI (neat), extended setting time of the primer system:

1 part by weight of Zonyl® 329 is mixed with 19 parts by weight of water and the mixture is applied by spraying at 100 g/m² to the substrate surface. The substrate is stored in the laboratory for 1 day at a temperature of approximately 20° C. and a relative atmospheric humidity of approximately 50%. The primer system produces no color deepening on the substrate. A drop of water is applied to the substrate. It evaporates completely from the substrate surface without penetrating into the substrate (no dark spot). A drop of n-decane applied to the substrate and left to act for 30 seconds, can be removed without leaving a dark spot. Thereafter neat AGI is applied to the surface by spraying in two passes with an overall product consumption of 100 g/m². Between the application passes, fine droplets on the substrate surface are spread with a brush to form a uniform film of liquid. The drying time between passes is ½ an hour. The final drying and curing time is around 16 hours at a temperature of approximately 60° C. The felttip test is passed. The impregnation produces no color deepening on the substrate.

### Example 8

Priming with Zonyl® 329 (dilute), impregnation with Goldschmidt HL 100 (neat):

1 part by weight of Zonyl® 329 is mixed with 4 parts by weight of water and the mixture is applied by spraying at 100 g/m² to the substrate surface. The substrate is stored in the laboratory for 1 day at a temperature of approximately 20° C. and a relative atmospheric humidity of approximately 50%. The primer system produces only slight color deepening on the substrate. A drop of water is applied to the substrate. It evaporates completely from the substrate surface without penetrating into the substrate (no dark spot). A drop of n-decane applied to the substrate and left to act for 30 seconds, can be removed without leaving a dark spot. Thereafter HL 100 is applied to the surface by spraying in one pass and dried at a temperature of approximately 20° C. and a relative atmospheric humidity of approximately 50%. The final drying and curing time is around 16 hours at a temperature of approximately 60° C. The product consumption in this case is 50 g/m². The substrate exhibits a strong water repellency effect. The felttip test, however, is not passed, since the impregnation does not exhibit any oleophobizing effect and the primer system lacks sufficient antigraffiti properties, owing to its use in dilute form. The impregnation produces only slight color deepening on the substrate.

### Example 9 (Comparative Example)

Priming with Goldschmidt HL 100 (dilute), impregnation with neat AGI:

1 part by weight of HL 100 is mixed with 9 parts by weight of ethanol. The dilute solution is applied by spraying to the surface of the substrate, with a product consumption of 100 g/m². After a reaction time of 1 week at a temperature of approximately 20° C. and a relative atmospheric humidity of about 50%, the substrate surface has one drop of water applied to it. The drop evaporates without penetrating into the substrate. A drop of n-decane applied to the substrate penetrates into it immediately (no oleophobic properties). Thereafter neat AGI is applied to the surface by spraying in two passes, with a total product consumption of 100 g/m². Between the application passes, fine droplets on the substrate surface are spread with a brush to form a uniform film of liquid. The drying time between the application passes is ½ an hour. The final drying and curing time is around 16 hours at a temperature of approximately 60° C. The felttip test is passed. The impregnation produces color deepening on the substrate.

1. A method of mitigating or preventing substrate discoloring when impregnating a porous inorganic substrate, comprising,
applying a primer to the substrate surface,
drying and curing the primer,
wherein the primer is applied at a rate of from 25 to 200 g/m² and dried and cured at a temperature of from 5 to 60° C. and at a relative atmospheric humidity of from 0% to 90%,
wherein the substrate surface, as a result of the primer application, drying and curing, acquires hydrophobic and oleophobic properties such that a drop of water applied thereto evaporates before it penetrates into the substrate, and a drop of n-decane likewise applied thereto and left to act for 30 seconds can be removed, without the either of the drops leaving dark spots on the substrate surface, and
carrying out the impregnation, thereby preventing or mitigating substrate discoloration during impregnation.

2. The method as claimed in claim 1, wherein the primer comprises at least one fluorofunctional component.

3. The method as claimed in claim 1, wherein the primer comprises at least one fluoroalkylsilyl-functional component.

4. The method as claimed in claim 1, wherein the primer comprises at least one cocondensate of at least one fluoroalkyl-functional silane and at least one aminoalkyl-functional silane.

5. The method as claimed in claim 1, wherein the primer comprises at least one fluoroalkyl-modified acrylate polymer.

6. The method as claimed in claim 1, wherein the primer comprises at least one fluorofunctional acrylic copolymer.

7. The method as claimed in claim 1, wherein concentrated active substance systems or concentrated active substance systems diluted with water, alcohol, or water and alcohol are used as primers.

8. The method as claimed in claim 1, wherein the primer comprises a fluorofunctional active substance content of from 0.5% to 30% by weight.

9. The method as claimed in claim 1, wherein the primer is applied by spraying, brushing, rolling or knife coating.

10. The method as claimed in claim 1, wherein the primer system is dried and cured for at least 4 hours before the impregnation is carried out.

11. The method as claimed in claim 1, wherein the carrying out the impregnation comprises applying an impregnating composition by spraying, brushing, rolling or knife coating.

12. The method as claimed in claim 11, wherein the impregnating composition is applied by spraying, and wherein the spraying comprises an airless or HVLP process.

13. The method of claim 1, wherein the primer comprises fluoroalkyl-modified and/or fluorofunctional acrylate systems or fluoroalkyl-/aminoalkyl-/alkoxy- and/or hydroxy-functional siloxane systems or fluoroalkyl-functional silane and/or siloxane systems or mixtures of at least two of the aforementioned substances or solutions thereof in water, alcohol and/or solvents.

14. The method of claim 1, wherein the method is a method of preventing.

15. The method of claim 1, wherein the method is a method of mitigating.

16. The method as claimed in claim 2, wherein the carrying out the impregnation comprises applying an impregnating composition by spraying, brushing, rolling or knife coating.

17. The method as claimed in claim 3, wherein the carrying out the impregnation comprises applying an impregnating composition by spraying, brushing, rolling or knife coating.

18. The method as claimed in claim 4, wherein the carrying out the impregnation comprises applying an impregnating composition by spraying, brushing, rolling or knife coating.

19. The method as claimed in claim 5, wherein the carrying out the impregnation comprises applying an impregnating composition by spraying, brushing, rolling or knife coating.

20. The method as claimed in claim 6, wherein the carrying out the impregnation comprises applying an impregnating composition by spraying, brushing, rolling or knife coating.
